(19) United States
(12) Patent Application Publication
(10) Pub. No.: US 2007/0236410 A1
(43) Pub. Date: Oct. 11, 2007

(54) Image display apparatus and display screen burn-in prevention method

(75) Inventor: Yoshiharu Shimizu, Tokyo (JP)

Correspondence Address: DRINKER BIDDLE & REATH (DC), 1500 K STREET, N.W., SUITE 1100, WASHINGTON, DC, 20005-1209, US

(73) Assignee: PIONEER CORPORATION

(21) Appl. No.: 11/727,657

(22) Filed: Mar. 27, 2007

(30) Foreign Application Priority Data
Mar. 30, 2006 (JP) 2006-093848

(51) Int. Cl. G09G 1/14; H04N 3/20

(52) U.S. Cl. 345/20; 348/173

(57) ABSTRACT

A display position of an entire image in one frame of an input image signal is moved as time elapses. When there is a region displayed with a constant image signal level for a predetermined period in the moving image, level adjustment is performed on the image signal for only this region to reduce the signal level of that region.

### BACKGROUND OF THE INVENTION

1. Field of the Invention

The present invention relates to a burn-in prevention function for preventing burn-in on a display screen in an image display apparatus.

2. Description of the Related Art

Some types of display devices, such as CRTs (Cathode Ray Tubes) and plasma display panels, perform display by employing a light emitting phenomenon that accompanies excitation of luminescent bodies. In such display devices, so called “burn-in” occurs in which the luminescent bodies degrade when the same level of brightness (luminance) is maintained for a long period.

In order to prevent such burn-in, burn-in prevention methods such as orbiting have been proposed. During the orbiting, a display position for an image on a screen is gradually moved as a whole so that a change in brightness is forced in each pixel. One example of the burn-in prevention methods is disclosed in Japanese Patent Application Kokai (Laid open) No. 2000-227775.

If burn-in prevention is done through orbiting, some regions may not undergo a change in brightness, particularly when the displayed image (object) having a comparably large display area of a substantially uniform brightness is moved within the screen.

For example, as shown in FIG. 1A of the accompanying drawings, it should be assumed that a display object QB displayed with a uniform brightness is moved as indicated by the dashed line. As shown in FIG. 1B of the accompanying drawings, the display object QB gradually moves to a position P1 indicated by the one-dot chain line, then to a position P2 indicated by the dashed line, and then to a position P3 indicated by the two-dot chain line. However, in a region MG shown in FIG. 1B, a portion of the display object QB always overlaps. Hence, the region MG is constantly displayed at the brightness of the display object QB, thus burn-in will occur.

### SUMMARY OF THE INVENTION

One object of the present invention is to provide an image display apparatus that can reliably prevent burn-in in a display screen.

Another object of the present invention is to provide a burn-in prevention method that can reliably prevent burn-in in a display screen.

According to a first aspect of the present invention, there is provided an image display apparatus that has a burn-in prevention function for a display screen. The image display apparatus includes a display position movement unit for obtaining a display-position-moving image signal. The display-position-moving image signal is obtained by performing orbiting process on an input image signal. The orbiting processing moves a display position of an entire image in one frame of the input image signal as time elapses. The image display apparatus also includes an image signal-level adjustment unit. When there is a region displayed with a constant (or substantially uniform) brightness (luminance) for a predetermined period in an image indicated by the display-position-moving image signal, the image signal-level adjustment unit adjusts the level of the display-position-moving image signal to reduce the brightness level in the region.

According to a second aspect of the present invention, there is provided a display screen burn-in prevention method for preventing burn-in in a display screen of an image display apparatus. The burn-in prevention method includes the step of obtaining a display-position-moving image signal by performing orbiting processing on an input image signal. The orbiting processing causes a display position of an entire image in one frame of the input image signal to move as time elapses. The burn-in prevention method also includes the step of adjusting the brightness (luminance) level of the display image signal when there is a region displayed with a constant brightness for a predetermined period in an image indicated by the display-position-moving image signal. The brightness level of the display-position-moving image signal is adjusted to reduce the brightness level in the region.

According to a third aspect of the present invention, there is provided an image display apparatus having a burn-in prevention function for a display screen of a display device having a plurality of display pixels. The image display apparatus includes a display position movement unit for obtaining a display-position-moving image signal. The display-position-moving image signal is obtained by performing orbiting processing on an input image signal. The orbiting processing moves a display position of an entire image in one frame of the input image signal as time elapses. The image display apparatus also includes an accumulated image signal-level calculator for generating an accumulated image signal level indicating an accumulation calculation result obtained by cumulatively adding the signal levels, indicated by the display-position-moving image signal, for each of the display pixels for a predetermined period. The image display apparatus also includes an image-signal-level adjustment unit for adjusting the signal level of the display-position-moving image signal corresponding to each of the display pixels in accordance with the accumulated image signal level to be given to the display pixel concerned.

According to a fourth aspect of the present invention, there is provided an image display apparatus having a burn-in prevention function for a display screen of a display device having a plurality of display pixels. The image display apparatus includes a display position movement unit for obtaining a display-position-moving image signal by performing orbiting processing on an input image signal. The orbiting processing moves a display position of an entire image in one frame of the input image signal as time elapses. The image display apparatus also includes an accumulated image signal-level prediction calculator for generating an accumulated image signal level, for each of the display pixels for a predetermined period, taking into account the orbiting movement of the display-position-moving image signal. The accumulated image signal level indicates an accumulation calculation prediction result obtained by cumulatively adding the signal levels. The signal levels are indicated by the input image signal. The image display apparatus also includes an image signal-level adjustment unit for adjusting the signal level of the display-position-moving image signal to be supplied to each of the display pixels in accordance with the accumulated image signal level to be given to the display pixel concerned.

According to a fifth aspect of the present invention, there is provided an image display apparatus having a burn-in prevention function for a display screen of a display device having a plurality of display pixels. The image display apparatus includes a display position movement unit for obtaining a display-position-moving image signal by performing orbiting processing on an input image signal. The orbiting processing moves a display position of an entire image in one frame of the input image signal as time elapses. The image display apparatus also includes an accumulated image signal-level calculator for generating an accumulated image signal level indicating an accumulation calculation result. The accumulation calculation result is obtained by cumulatively adding the signal levels, indicated by the display-position-moving image signal, for each display pixel block formed from a certain number of display pixels, for a predetermined period. The image display apparatus also includes an image-signal-level adjustment unit for adjusting the signal level of the display-position-moving image signal given to each of the display pixels belonging to the display pixel block in accordance with the accumulated image signal level given to the display pixel block.

According to a sixth aspect of the present invention, there is provided an image display apparatus having a burn-in prevention function for a display screen of a display device having a plurality of display pixels. The image display apparatus includes a display position movement unit for obtaining a display-position-moving image signal by performing, on an input image signal, processing of moving a display position of an entire image in one frame of the input image signal as time elapses. The image display apparatus also includes an accumulated image signal-level prediction calculator for generating an accumulated image signal level indicating an accumulation calculation prediction result. The accumulation calculation prediction result is obtained by cumulatively adding the signal levels, indicated by the input image signal, for each display pixel block formed from some display pixels, for a predetermined period, taking into account the orbiting movement of the display-position-moving image signal. The image display apparatus also includes an image-signal-level adjustment unit for adjusting the signal level of the display-position-moving image signal to be given to each of the display pixels belonging to the display pixel block in accordance with the accumulated image signal level applied to the display pixel block concerned.

According a seventh aspect of the present invention, there is provided an image display apparatus having a burn-in prevention function for a display screen of a display device having a plurality of display pixels. The image display apparatus includes a display position movement unit for performing, on an input image signal, processing of moving a display position of an entire image in one frame based on the input image signal as time elapses, to generate a first display-position-moving image signal. The image display apparatus also includes a second display-position-moving image signal in which the display position of the entire image moves as time elapses in a movement pattern different from the first display-position-moving image signal. The image display apparatus also includes a first accumulated image signal-level prediction calculator for generating a first accumulated image signal level indicating an accumulation calculation prediction result obtained by cumulatively adding the signal levels, indicated by the input image signal, for each of the display pixels for a predetermined number of frames, taking into account the orbiting movement of the first display-position-moving image signal. The image display apparatus also includes a second accumulated image signal-level prediction calculator for generating a second accumulated image signal level indicating an accumulation calculation prediction result. The accumulation calculation prediction result is obtained by cumulatively adding the signal levels, indicated by the input image signal, for each of the display pixels for a predetermined number of frames, taking into account the orbiting movement of the second display-position-moving image signal. The image display apparatus also includes an image signal-level controller for generating a selection signal indicating one of the first display-position-moving image signal and the second display-position-moving image signal, on the basis of a comparison result of the level of the first display-position-moving image signal and the level of the second display-position-moving image signal corresponding to the display pixels in one frame or a portion of one frame. The display position movement unit generates one of the first display-position-moving image signal and the second display-position-moving image signal, as indicated by the selection signal.

According to an eighth aspect of the present invention, there is provided a display screen burn-in prevention method for a display device having a plurality of display pixels. The burn-in prevention method includes the step of obtaining a display-position-moving image signal by performing, on an input image signal, processing of moving a display position of an entire image in one frame of the input image signal as time elapses. The burn-in prevention method also includes the step of generating an accumulated image signal level indicating an accumulation calculation result. The accumulation calculation result is obtained by cumulatively adding the signal levels, indicated by the display-position-moving image signal, for each of the display pixels for a predetermined period. The burn-in prevention method also includes the step of adjusting the signal level of the display-position-moving image signal corresponding to each of the display pixels in accordance with the accumulated image signal level corresponding to the display pixel concerned.

According to a ninth aspect of the present invention, there is provided a display screen burn-in prevention method for a display device having a plurality of display pixels. The burn-in prevention method includes the step of obtaining a display-position-moving image signal by performing, on an input image signal, processing of moving a display position of an entire image in one frame of the input image signal as time elapses. The burn-in prevention method also includes the step of generating an accumulated image signal level indicating an accumulation calculation prediction result obtained by cumulatively adding the signal levels, indicated by the input image signal, for each of the display pixels for a predetermined period, taking into account the orbiting movement of the display-position-moving image signal. The burn-in prevention method also includes the step of adjusting the signal level of the display-position-moving image signal corresponding to each of the display pixels in accordance with the accumulated image signal level corresponding to the display pixel concerned.

According to a tenth aspect of the present invention, there is provided a display screen burn-in prevention method for a display device having a plurality of display pixels. The burn-in prevention method includes the step of obtaining a display-position-moving image signal by performing, on an input image signal, processing of moving a display position of an entire image in one frame of the input image signal as time elapses. The burn-in prevention method also includes the step of generating an accumulated image signal level indicating an accumulation calculation result obtained by cumulatively adding the signal levels, indicated by the display-position-moving image signal, for each display pixel block formed from a certain number of display pixels, for a predetermined period. The burn-in prevention method also includes the step of adjusting the signal level of the display-position-moving image signal corresponding to each of the display pixels belonging to the display pixel block in accordance with the accumulated image signal level corresponding to the display pixel block.

According to an eleventh aspect of the present invention, there is provided a display screen burn-in prevention method for a display device having a plurality of display pixels. The burn-in prevention method includes the step of obtaining a display-position-moving image signal by performing, on an input image signal, processing of moving a display position of an entire image in one frame of the input image signal as time elapses. The burn-in prevention method also includes the step of generating an accumulated image signal level indicating an accumulation calculation prediction result obtained by cumulatively adding the signal levels, indicated by the input image signal, for each display pixel block formed from a certain number of display pixels, for a predetermined period, taking into account the orbiting movement based on the display-position-moving image signal. The burn-in prevention method also includes the step of adjusting the signal level of the display-position-moving image signal corresponding to each of the display pixels belonging to the display pixel block in accordance with the accumulated image signal level corresponding to the display pixel block.

According to a twelfth aspect of the present invention, there is provided a display screen burn-in prevention method for a display device having a plurality of display pixels. The burn-in prevention method includes the step of performing, on an input image signal, processing of moving a display position of an entire image in one frame of the input image signal as time elapses, to generate a first display-position-moving image signal and a second display-position-moving image signal in which the display position of the entire image moves as time elapses in a movement pattern different from the first display-position-moving image signal. The burn-in prevention method includes the step of generating a first accumulated image signal level indicating an accumulation calculation prediction result obtained by cumulatively adding the signal levels, indicated by the input image signal, for each of the display pixels for a predetermined number of frames, taking into account the orbiting movement based on the first display-position-moving image signal. The burn-in prevention method includes the step of generating a second accumulated image signal level indicating an accumulation calculation prediction result. The accumulation calculation prediction result is obtained by cumulatively adding the signal levels, indicated by the input image signal, for each of the display pixels for a predetermined number of frames, taking into account the orbiting movement based on the second display-position-moving image signal. The burn-in prevention method includes the step of generating a selection signal indicating one of the first display-position-moving image signal and the second display-position-moving image signal, on the basis of a comparison result of the level of the first display-position-moving image signal and the level of the second display-position-moving image signal corresponding to the display pixels in one frame or a portion of one frame. In the display position movement step, one of the first display-position-moving image signal and the second display-position-moving image signal as indicated by the selection signal is generated (selected).

The display position of the entire image in one frame of the input image signal is moved as time elapses. When there is a region displayed with a substantially constant brightness for a predetermined period in the moving image, level adjustment is performed on the image signal to reduce the signal level for only this region. If the image is caused to move with the time and an overlapping region arises having a substantially uniform brightness, adjustment processing is performed to reduce the level of the image signal for only this overlapping region. Hence display screen burn-in is reliably prevented.

In the overlapping region, preferably the image signal level is not changed when the average image signal level in the overlapping region is smaller than a predetermined level. In the overlapping region, preferably the image signal level is reduced in inverse proportion to the size of the average signal level when the average signal level in the region is greater than the predetermined level.

Preferably, the signal level in a surrounding region around the overlapping region is gradually changed. The degree of reducing the signal level for the surrounding region is gradually changed toward the overlapping region. With this gradation, the display screen burn-in prevention is achieved without destroying natural balance (impression) of the displayed image.

Adjustment may be performed on the image signal level to be given to display pixels (or display pixel block) in accordance with an accumulation calculation result obtained by cumulatively adding the signal levels for each of the display pixels (or display pixel block) for a predetermined period, while moving the display position of the entire image in one frame of the input image signal as time elapses. The image signal level may not be changed when the accumulation calculation result is smaller than a predetermined value, and the image signal is adjusted to reduce the signal level in inverse proportion to the size of the accumulation calculation result when the accumulation calculation result is greater than the predetermined value. With this structure or approach, even if a portion of a display image is constantly an overlapping region when the display image is moved due to orbiting processing, adjustment is performed to reduce the image signal level in this region. Thus, the display screen burn-in is reliably prevented without creating an unnatural impression in the displayed image.

### BRIEF DESCRIPTION OF THE DRAWINGS

FIGS. 1A and 1B show one example of an overlapping region occurring due to orbiting processing;

FIG. 2 shows a block diagram of an image display apparatus according to a first embodiment of the present invention;

FIG. 3 shows the flowchart of burn-in region detection processing;

FIG. 4 depicts one example when a plurality of burn-in candidates exist in one screen;

FIGS. 5A to 5C show a portion of storage contents in a memory;

FIG. 6 is a diagram showing relationship between an adjustment coefficient for an image signal-level adjustment signal, and accumulated image signal-level information;

FIGS. 7A to 7D illustrate a series of operations performed by the image display apparatus of one embodiment according to the present invention;

FIG. 8 illustrates a block diagram of an image display apparatus according to a second embodiment of the present invention;

FIG. 9 illustrates a pixel arrangement in a display screen in a display device according to the second embodiment;

FIG. 10 is a diagram showing relationship between a representative accumulated image signal level and an image signal-level reduction rate for an image signal-level adjustment signal;

FIG. 11 illustrates a modification to the image display apparatus shown in FIG. 8; and

FIG. 12 illustrates a modification to the image display apparatus shown in FIG. 11.

### DETAILED DESCRIPTION OF THE INVENTION

### First Embodiment

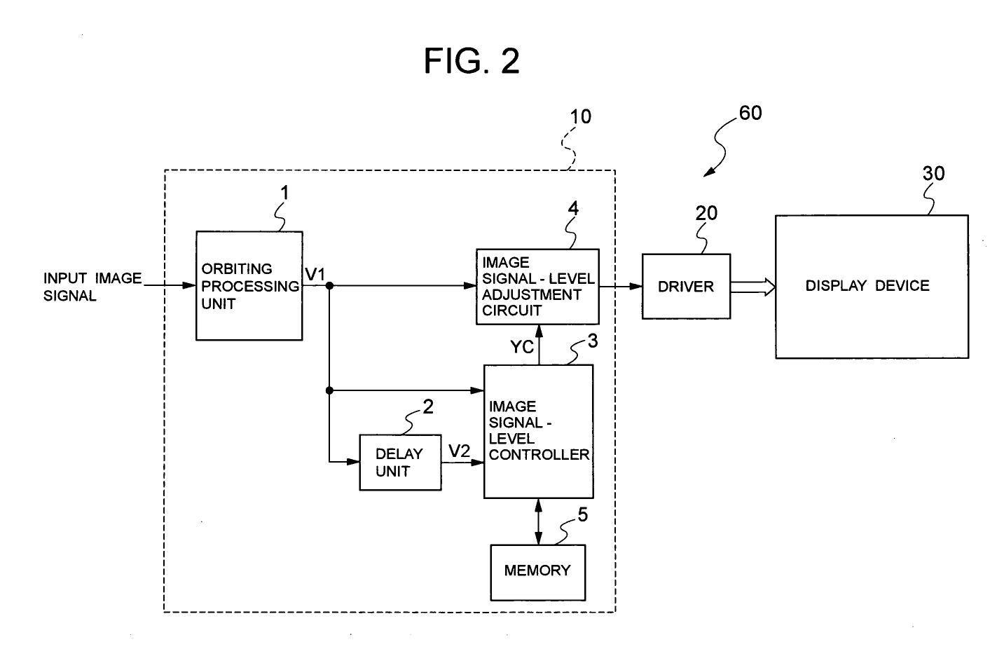

Referring to FIG. 2, a basic structure of an image display apparatus 60 according to a first embodiment of the present invention will be described. The image display apparatus 60 has a display screen burn-in prevention function.

As shown in FIG. 2, the image display apparatus 60 includes a burn-in prevention circuit 10, a driver 20 and a display device 30. The display device 30 is a CRT (Cathode Ray Tube), a plasma display or the like.

The burn-in prevention circuit 10 has an orbiting processing circuit 1. The orbiting processing circuit 1 performs processing on an input image signal to move a display position of an entire image for one frame based on the input image signal as time elapses, and obtains a display-position-moving image signal V1. Then, the orbiting processing circuit 1 supplies the display-position-moving image signal V1 to each of a delay circuit 2, an image signal-level control circuit 3 and an image signal-level adjustment circuit 4. It should be noted that usually an actual display pixel has a plurality of color cells (e.g., red (R), green (G), and blue (B)). When each pixel in the display device 30 is structured from three (red, green and blue, or RGB) pixel cells, the input image signal is three (RGB) image signals. In this case, the brightness (luminance) of an image to be displayed is determined by the levels of the red, green and blue (RGB) image signals. The brightness is higher as the signal level is higher. It should note noted, however, that the image signal level does not always indicate only brightness (luminance).

The delay circuit 2 delays the display-position-moving image signal V1 for a predetermined period, and supplies this signal as another display-position-moving image signal V2 to the image signal-level control circuit 3. The predetermined period is a display period of t frames (t being a positive integer). Hence, the first display-position-moving image signal V1, corresponding to a current frame, and the second display-position-moving image signal V2, corresponding to a frame t frames prior to (in the past) the current frame, are supplied to the image signal-level control circuit 3.

The image signal-level control circuit 3 executes burn-in region detection processing (to be described below) on the basis of the display-position-moving image signals V1 and V2. Such burn-in region detection processing allows the image signal-level control circuit 3 to detect an image region that is predicted to experience burn-in. The image-signal-level control circuit 3 generates an image signal-level adjustment signal YC representing an adjustment coefficient for reducing brightness (luminance) in an image to be displayed in that predicted region. The image signal-level control circuit 3 supplies the image signal-level adjustment signal YC to the image signal-level adjustment circuit 4. The image signal-level adjustment circuit 4 adjusts the brightness level of the display-position-moving image signal V1 according to the adjustment coefficient represented by the image signal-level adjustment signal YC, and supplies this adjusted signal as a burn-in prevented image signal to the driver 20. The driver 20 generates various drive signals for displaying an image according to the burn-in prevented image signal, and supplies the drive signals to the display device 30. The display device 30 displays an image in accordance with the drive signals supplied from the driver 20.

Next, a detailed explanation will be given of the burn-in region detection processing as performed by the image signal-level control circuit 3.

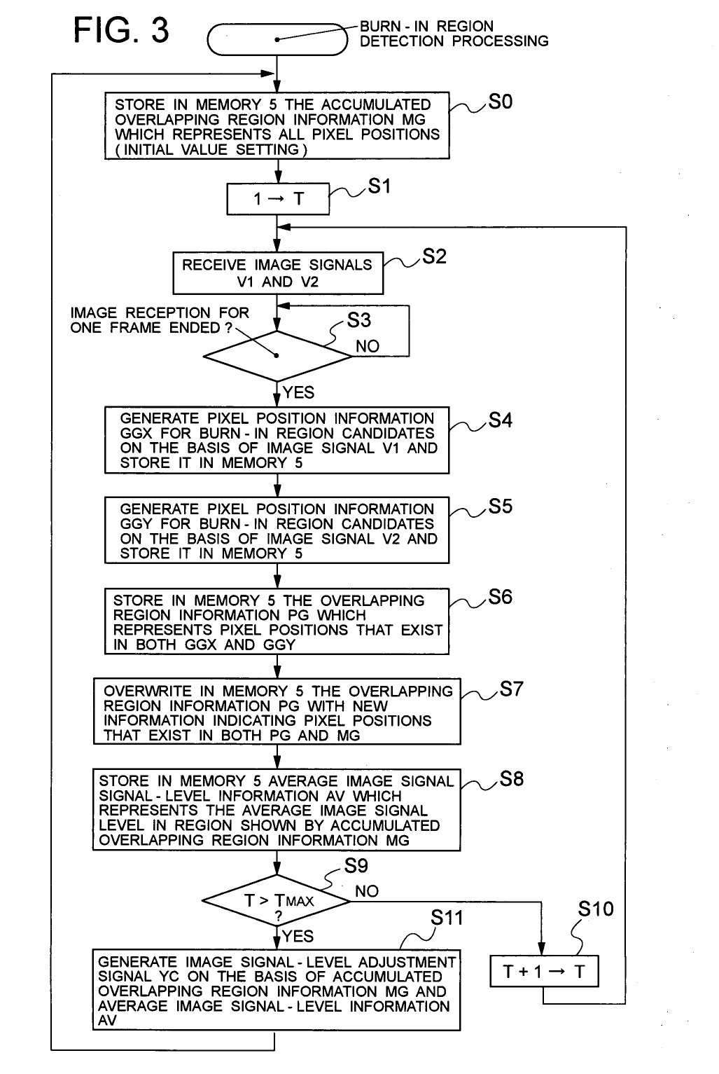

FIG. 3 shows the flowchart of burn-in region detection processing.

In FIG. 3, the image signal-level control circuit 3 first stores in the memory 5 information indicating the pixel positions of all the pixels, as initial values of accumulated overlapping region information MG (to be described below) (step S0). Next, the image signal-level control circuit 3 stores in an internal register (not shown in the drawings) an initial value of “1” for an elapsed period T (step S1). Then the image signal-level control circuit 3 receives the display-position-moving image signals V1 and V2 separately (step S2). Then, the image signal-level control circuit 3 determines whether the receiving of the image signals has completed for the display-position-moving image signals V1 and V2 in one frame. This determination is repeated until the image signal-level control circuit 3 determines that the signal reception has completed for one frame (step S3).

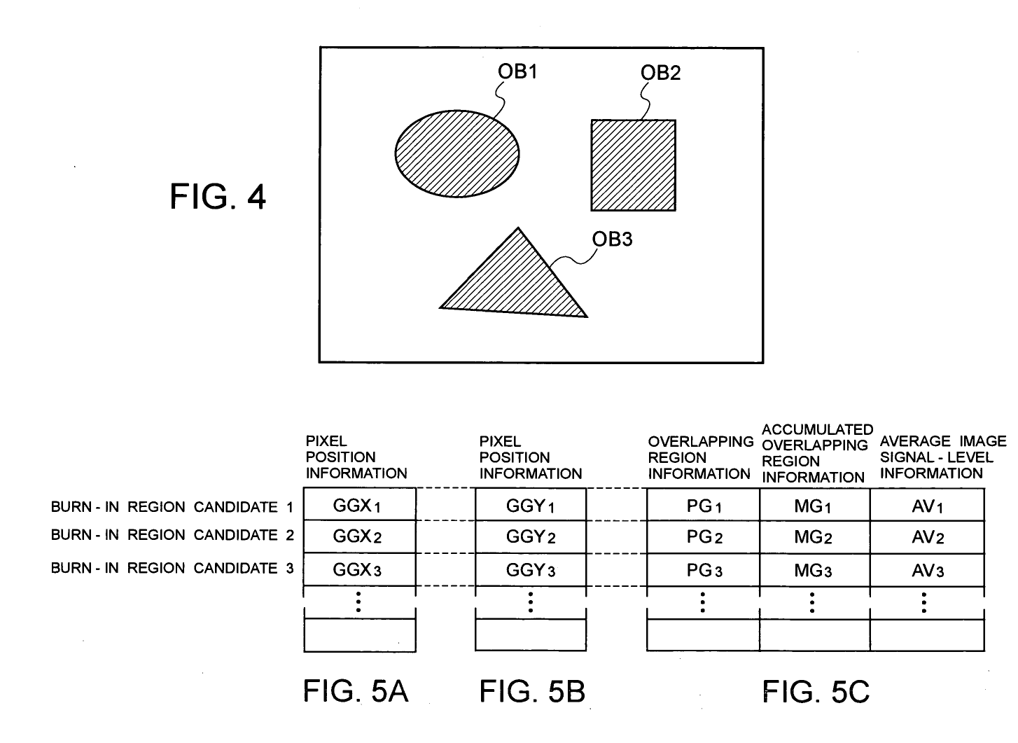

In step S3, when a determination is made that the reception of the display-position-moving image signals V1 and V2 is ended for one frame, the image signal-level control circuit 3 detects a burn-in region candidate in the display-position-moving image signal V1. More specifically, the image signal-level control circuit 3 looks at the one-frame-worth of display-position-moving image signal V1 to detect, as a burn-in region candidate, a region which has a display area equal to or greater than a predetermined size and which has a signal level difference (i.e., difference between the lowest signal level and the highest signal level) smaller than a predetermined value. In other words, a comparably large display region displayed at a substantially uniform level is detected as a candidate region having a possibility of burn-in occurring. Then the image signal-level control circuit 3 stores in the memory 5 pixel position information GGX representing all the pixel positions in this region. The pixel position information GGX is information representing this burn-in region candidate. It should be noted that when a plurality of burn-in region candidates are detected in one screen, the image signal-level control circuit 3 generates separate pixel position information GGX for each of the burn-in region candidates and stores this information in the memory 5. For example, as shown in FIG. 4, when three burn-in region candidates OB1, OB2 and OB3 are detected in the image of one frame, the image signal-level control circuit 3, as shown in FIG. 5A, stores in the memory 5 pixel position information GGX₁ corresponding to the first burn-in region candidate OB1, pixel position information GGX₂ corresponding to the second burn-in region candidate OB2, and pixel position information GGX₃ corresponding to the third burn-in region candidate OB3 (step S4).

When the burn-in region candidate detection processing of the step S4 (FIG. 3) is ended for the display-position-moving image signal V1, the image signal-level control circuit 3 then executes another burn-in region candidate detection processing for the display-position-moving image signal V2 in the same manner as in the step S4 (step S5). More specifically, the image signal-level control circuit 3 uses one-frame-worth of display-position-moving image signal V2 to detect, as a burn-in region candidate, a region which has a display area equal to or greater than a predetermined size and which has a signal level difference (i.e., difference between the lowest signal level and the highest signal level) smaller than a predetermined value. In other words, a relatively large display region displayed at a substantially uniform level is taken as a candidate region having a possibility of burn-in occurring. Then the image signal-level control circuit 3 stores in the memory 5, as depicted in FIG. 5B, pixel position information GGY representing all the pixel positions in this region as information representing this burn-in region candidate. When a plurality of burn-in region candidates are detected in one screen, the image signal-level control circuit 3 generates separate pixel position information GGY for each burn-in region candidate and stores this information in the memory 5 (step S5).

When the burn-in region candidate detection processing of the step S5 is ended for the display-position-moving image signal V2, the image signal-level control circuit 3 detects the region where the burn-in region candidate derived from the display-position-moving image signal V1 and the burn-in region candidate derived from the display-position-moving image signal V2 overlap. More specifically, the image signal-level control circuit 3 extracts from all of the pixel positions only the pixel positions common to both the pixel position information GGX and GGY, and stores (overwrites) the information representing the extracted pixel positions in the memory 5, as the overlapping region information PG. As shown in FIGS. 5A and 5B, when there is a plurality of pixel position information GGXi (or GGYi), i.e., when there is a plurality of burn-in region candidates, the image signal-level control circuit 3 stores (overwrites) each overlapping region information PGi corresponding to each pixel position information GGXi (or GGYi) in the memory 5, as shown in FIG. 5C (step S6).

Next, the image signal-level control circuit 3 extracts from all of the pixel positions only the pixel positions common to the overlapping region information PG and the accumulated overlapping region information MG, which is associated with the overlapping region information PG concerned, and is stored in the memory 5 as shown in FIG. 5C. The signal level control circuit 3 stores (overwrites) the information indicating the extracted pixel positions in the memory 5, as the updated accumulated overlapping region information MG (step S7). More specifically, the execution of step S7 stores the region, in which the accumulated overlapping region (MG) currently stored in the memory 5 and the overlapping region (PG) overlap, in the memory 5 by overwriting, as new accumulated overlapping region information MG.

Next, the image signal-level control circuit 3 calculates the average level of the display-position-moving image signal V1 (or V2) corresponding to the pixel positions represented by the new (updated) accumulated overlapping region information MG, and stores this result as average image signal-level information AV in the memory 5, as shown in FIG. 5C (step S8). The average level information AV is associated with the accumulated overlapping region information MG concerned.

Then, the image signal-level control circuit 3 determines whether an elapsed time T stored in the internal register exceeds a predetermined time T_{MAX} (step S9). When step 59 makes a determination that the elapsed time T does not exceed the predetermined time T_{MAX}, the image signal-level control circuit 3 adds “1” to the current “elapsed time T” and stores (overwrites) the result in the internal register as a new elapsed time T (step S10). After step S10 is executed, the image signal-level control circuit 3 returns to the step S2 and repeats the operation described above.

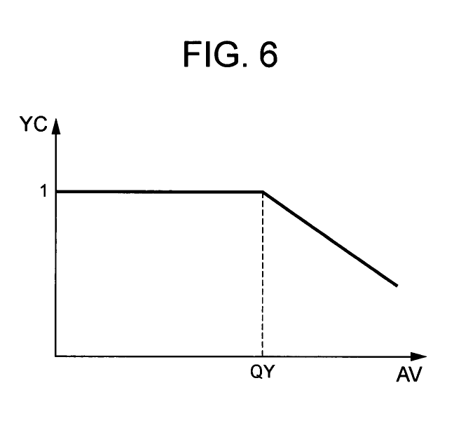

On the other hand, when the step S9 determines that the elapsed time T has exceeded the time T_{MAX}, the image signal-level control circuit 3 generates an image signal-level adjustment signal YC, for each pixel, representing an adjustment coefficient to be applied on a signal level of the display-position-moving image signal V1, on the basis of the accumulated overlapping region information MG and the average image signal-level information AV stored in the memory 5. The image signal-level control circuit 3 supplies the signal level adjustment signals YC to the image signal-level adjustment circuit 4. Specifically, the image signal-level control circuit 3 generates image signal-level adjustment signals YC representing an adjustment coefficient of “1” for the display-position-moving image signal V1 for all of the pixels not represented by the accumulated overlapping region information MG stored in the memory 5. The adjustment coefficient of “1” indicates that the display-position-moving image signal V1 should be supplied to the driver 20 with the unchanged signal level. The image signal-level control circuit 3 supplies the adjustment coefficient signal YC to the image signal-level adjustment circuit 4. On the other hand, the image signal-level control circuit 3 generates an image signal-level adjustment signal YC for the display-position-moving image signal V1 corresponding to each of the pixels represented by the accumulated overlapping region information MG, on the basis of the average image signal-level information AV of the accumulated overlapping region information MG. In other words, the image signal-level control circuit 3 generates an image signal-level adjustment signal YC representing an adjustment coefficient of “1” for the display-position-moving image signal V1 when, as shown in FIG. 6, an average signal level represented by the average image signal-level information AV is smaller than a predetermined level QY. However, when the average signal level represented by the average image signal-level information AV is greater than the predetermined level QY, the image signal-level control circuit 3, as shown in FIG. 6, generates an image signal-level adjustment signal YC representing an adjustment coefficient for reducing the signal level of the display-position-moving image signal V1 in inverse proportion to the size of the average signal level represented by the average image signal-level information AV. Then the image signal-level control circuit 3 supplies the adjustment signal YC to the image signal-level adjustment circuit 4. At this time, the image signal-level control circuit 3 also generates the image signal-level adjustment signal YC for gradually changing the degree of reduction of the signal levels. In other words, the level control circuit 3 prepares a gradually changing adjustment coefficient. The changing adjustment signal is applied to those pixels around the pixel group represented by the accumulated overlapping region information MG (i.e., the surrounding region of the accumulated overlapping region). The adjustment coefficient (adjustment signal) changes its value toward the accumulated overlapping region. Then the image signal-level control circuit 3 supplies such adjustment signals YC to the image signal-level adjustment circuit 4 (step S11).

Through the execution of the step S11, the image signal-level adjustment circuit 4 generates an image signal whose signal level is reduced only for the region represented by the accumulated overlapping region information MG and the surrounding region thereof among the one-frame-worth of image represented by the display-position-moving image signal V1, and then the image signal-level adjustment circuit 4 supplies the image signal to the driver 20 as a burn-in prevented image signal.

After the step S11 is executed, the image signal-level control circuit 3 returns to the step S1, and repeats the previously described operation.

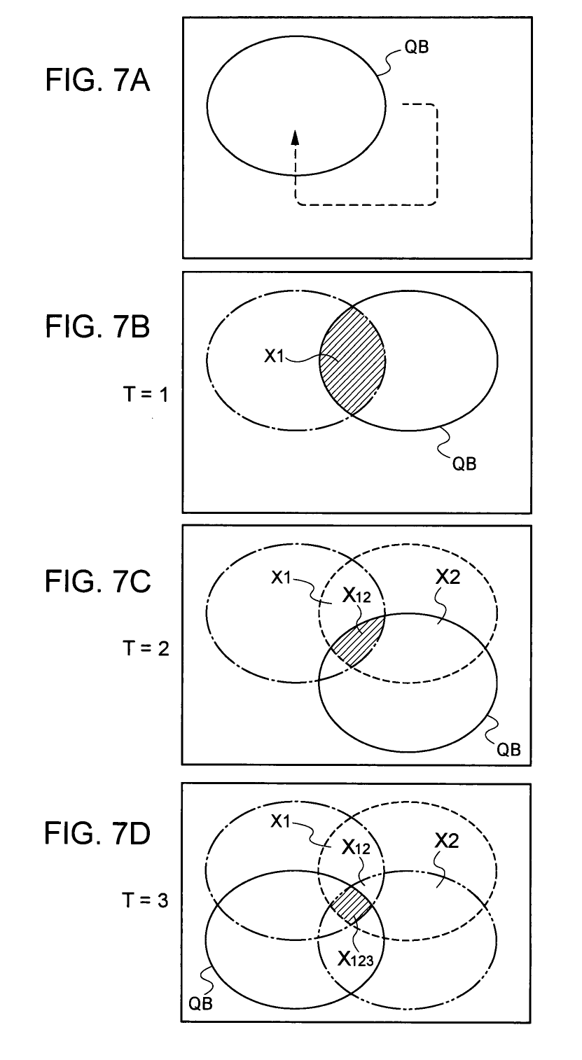

Next, an explanation will be given of the operation of the image signal-level control circuit 3 and the image signal-level adjustment circuit 4. The orbiting operation for one display object QB will be described with reference to FIGS. 7A to 7D.

FIG. 7A illustrates an initial position of the display object QB. This display object QB moves in the sequence shown in FIGS. 7B, 7C and 7D, due to the orbiting operation. FIG. 7B shows the position of the display object QB (as shown by the solid line) when time T=1 has elapsed from the state in FIG. 7A. The initial position of the display object QB is indicated by the one-dot chain line in FIG. 7B. FIG. 7C shows the position of the display object QB (as indicated by the solid line) when time T=2 has elapsed from the state in FIG. 7A. In FIG. 7C, the initial position of the display object QB is indicated by the one-dot chain line and the position of the display object QB when time T=1 has elapsed is indicated by the dashed line. FIG. 7D shows the position of the display object QB (as indicated by the solid line) when time T=3 has elapsed from the state in FIG. 7A. In FIG. 7D, the initial position of the display object QB is indicated by the one-dot chain line, the position of the display object QB when time T=1 has elapsed is indicated by the dashed line, and the position of the display object QB when time T=2 has elapsed is indicated by the two-dot chain line. It should be assumed that T_{MAX}=2 in the step S9 (FIG. 3).

When the elapsed time T is 1 (T=1), as shown in FIG. 7B, pixel position information GGX₁ of the display object QB positioned as indicated by the solid line is stored in the memory 5, as shown in FIG. 5A, and pixel position information GGY₁ of the display object QB positioned as indicated by the one-dot chain line is stored in the memory 5 (steps S4 and S5). Then, as shown in FIG. 7B, information representing an overlapping region X1 (as indicated by the shaded region), of the display object QB positioned as indicated by the solid line and the display object QB positioned as indicated by the one-dot chain line, is stored in the memory 5 as accumulated overlapping region information MG₁ (steps S6 and S7). Average image signal-level information AV₁ representing an average signal level in the region represented by the accumulated overlapping region information MG₁ is stored in the memory 5 (step S8).

When the elapsed time T is two (T=2), as shown in FIG. 7C, the pixel position information GGX₁ of the display object QB positioned as indicated by the solid line is stored (overwritten) in the memory 5, and pixel position information GGY₁ of the display object QB positioned as indicated by the dashed line is stored (overwritten) in the memory 5 (steps S4 and S5). Then, as illustrated in FIG. 7C, information indicating an overlapping region X₁₂ (as indicated by the shaded region), of an overlapping region X2, in which there is overlapping of the display object QB positioned as indicated by the solid line and the display object QB positioned as indicated by the dashed line, and of the overlapping region X1 represented by the accumulated overlapping region information MG₁ stored in the memory 5, is stored (overwritten) in the memory 5 as accumulated overlapping region information MG₁ (steps S6 and S7). Average image signal-level information AV₁ representing an average signal level in the region represented by the accumulated overlapping region information MG₁ is stored in the memory 5 (step S8).

When the elapsed time T is three (T=3), as depicted in FIG. 7D, the pixel position information GGX₁ of the display object QB positioned as indicated by the solid line is stored (overwritten) in the memory 5, and pixel position information GGY₁ of the display object QB positioned as indicated by the two-dot chain line is stored (overwritten) in the memory 5 (steps S4 and S5). Then, as shown in FIG. 7D, information indicating an overlapping region X₁₂₃ (as indicated by the shaded region), of an overlapping region X3, in which there is overlapping of the display object QB positioned as indicated by the solid line and the display object QB positioned as indicated by the two-dot chain line, and of the overlapping region X₁₂ represented by the accumulated overlapping region information MG₁ stored in the memory 5, is stored (overwritten) in the memory 5 as accumulated overlapping region information MG₁ (steps S6 and S7). Average image signal-level information AV₁ representing an average signal level in the region represented by the accumulated overlapping region information MG₁ is stored in the memory 5 (step S8).

Here, the elapsed time is T=3, which exceeds the predetermined time T_{MAX}=2. Thus, the image signal-level control circuit 3 generates the image signal-level adjustment signal YC on the basis of the accumulated overlapping region information MG₁ and average image signal-level information AV₁ stored in the memory 5 at this point in time. More specifically, the image signal-level control circuit 3 and the image signal-level adjustment circuit 4 reduce the signal levels of only the image signals to be given to the pixels in the overlapping region X₁₂₃ in accordance with the properties shown in FIG. 6.

Through the above-described operation, when the display object is moved with orbiting processing and a region exists in which a portion of the display object always overlaps, only this region has the reduced image signal level. Thus, burn-in is prevented reliably in the display screen without the occurrence of unnatural images (without giving unnatural feeling to a viewer).

### Second Embodiment

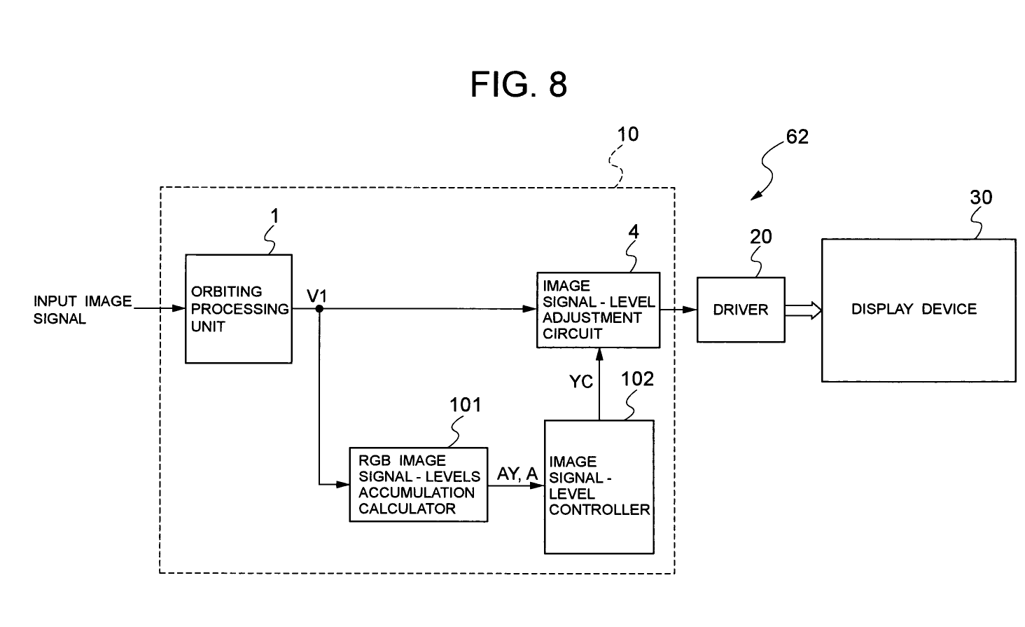

Referring to FIG. 8, a basic structure of an image display apparatus 62 according to a second embodiment of the present invention will be described. The image display apparatus 62 has a display screen burn-in prevention function. Similar reference numerals and symbols are used to designate similar elements and signals in the first and second embodiments.

As illustrated in FIG. 8, the image display apparatus 62 includes a burn-in prevention circuit 10, a driver 20 and a display device 30. The display device 30 has a CRT (Cathode Ray Tube), a plasma display or the like.

An orbiting processing circuit 1 of the burn-in prevention circuit 10 performs processing on an input image signal to move a display position of an entire image in one frame of the input image signal as time elapses to obtain a display-position-moving image signal V1. The orbiting processing circuit 1 supplies the display-position-moving image signal V1 to each of a RGB image signal-levels accumulation calculation circuit 101 and an image signal-level adjustment circuit 4.

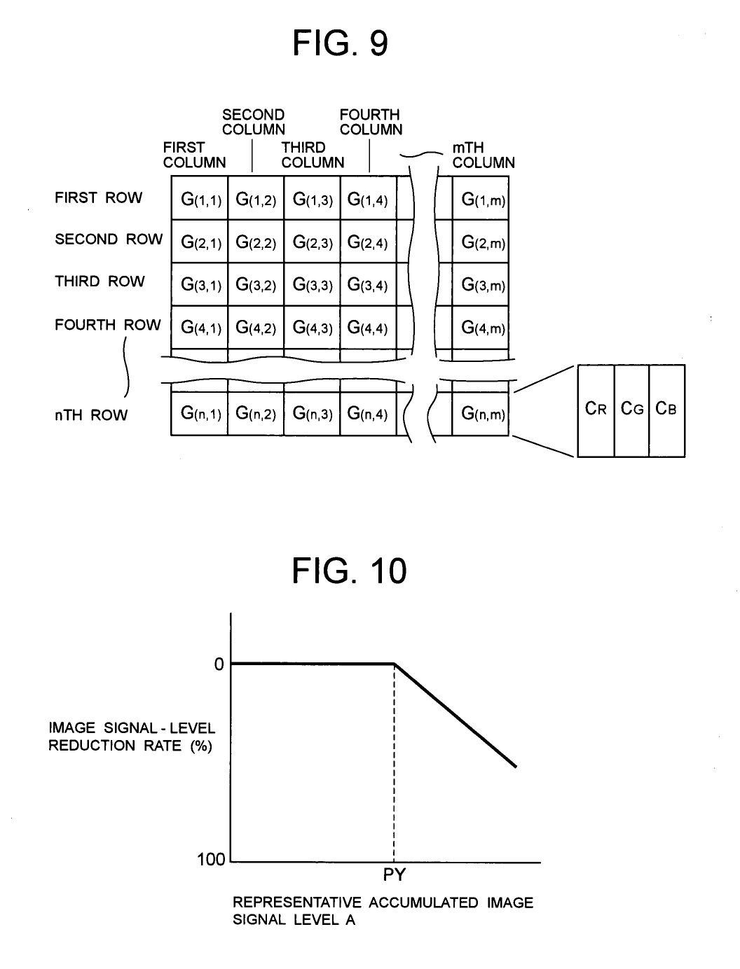

The display device 30 has pixels G(1,1) to G(n,m), as shown in FIG. 9. The RGB image signal-levels accumulation calculation circuit 101 executes accumulation calculations (addition) for the brightness (luminance) levels of three pixel cells belonging to each pixel G (i.e., a red pixel cell C_{R} for emitting red light, a green pixel cell C_{G} for emitting green light and a blue pixel cell C_{B} for emitting blue light) in a predetermined period on the basis of the display-position-moving image signal V1. Next, the RGB image signal-levels accumulation calculation circuit 101 generates for each pixel G a red accumulated image signal level AY_{R} showing the accumulation calculation result for the image signal level in the red pixel cell C_{R}, a green accumulated image signal level AY_{G} showing the accumulation calculation result for the image signal level in the green pixel cell C_{G}, and a blue accumulated image signal level AY_{B} showing the accumulation calculation result for the image signal-level in the blue pixel cell C_{B}. Then the RGB image signal-levels accumulation calculation circuit 101 calculates a representative accumulated image signal level A for each pixel G on the basis of the red accumulated image signal level AY_{R}, the green accumulated image signal level AY_{G} and the blue accumulated image signal level AY_{B}, and supplies this representative accumulated image signal level A to an image signal-level control circuit 102. For example, the RGB image signal-levels accumulation calculation circuit 101 performs accumulation calculations, for each pixel cell (C_{R}, C_{G} and C_{B}), of the signal levels for every ten consecutive frames in the display-position-moving image signal V1. Then the RGB image signal-levels accumulation calculation circuit 101 generates the red accumulated image signal level AY_{R}, the green accumulated image signal level AY_{G} and the blue accumulated image signal level AY_{B} showing each of the results of the accumulation calculations calculated for each pixel cell (C_{R}, C_{G} and C_{B}). The RGB image signal-levels accumulation calculation circuit 101 detects the maximum signal level among the red accumulated image signal level AY_{R}, the green accumulated image signal level AY_{G} and the blue accumulated image signal level AY_{B}, and supplies the maximum signal level as the representative accumulated image signal level A of the pixel G to the image signal-level control circuit 102. Note that a value between the minimum signal level and the maximum signal level of the red accumulated image signal level AY_{R}, the green accumulated image signal level AY_{G} and the blue accumulated image signal level AY_{B} may be employed as the representative accumulated image signal level A. Alternatively, the representative accumulated image signal level A may be the average value or the minimum value of the red accumulated image signal level AY_{R}, the green accumulated image signal level AY_{G} and the blue accumulated image signal level AY_{B}.

When display-position-moving image signals V1 corresponding to the first to the 12^{th} frames are supplied in sequence, the RGB image signal-levels accumulation calculation circuit 101 first obtains (calculates) the accumulation calculation results of the signal levels for the ten consecutive frames from the first to the tenth frame for each pixel cell (C_{R}, C_{G} and C_{B}), and then calculates the representative accumulated image signal level A of the red accumulated image signal level AY_{R}, the green accumulated image signal level AY_{G} and the blue accumulated image signal level AY_{B}, and supplies this signal level A to the image signal-level control circuit 102. Next the RGB image signal-levels accumulation calculation circuit 101 calculates, for each of the three pixel cells, the accumulation calculation result of the signal levels for the ten consecutive frames from the second frame to the 11^{th} frame and supplies the results to the image signal-level control circuit 102 as the red accumulated image signal level AY_{R}, the green accumulated image signal level AY_{G} and the blue accumulated image signal level AY_{B}. Then the RGB image signal-levels accumulation calculation circuit 101 calculates for each pixel cell the accumulation calculation results of the signal levels for the ten consecutive frames from the third frame to the 12^{th} frame and calculates the representative accumulated image signal level A of the red accumulated image signal level AY_{R}, the green accumulated image signal level AY_{G} and the blue accumulated image signal level AY_{B}. The representative accumulated signal level A is sent to the image signal level controller 102.

In this manner the RGB image signal-levels accumulation calculation circuit 101 calculates accumulated image signal levels in a predetermined period for each red pixel cell, green pixel cell and blue pixel cell in each pixel on the basis of the display-position-moving signals V1, and further obtains a representative accumulated image signal level on the basis of accumulated image signal levels for each pixel.

The image signal-level control circuit 102 generates an image signal-level adjustment signal YC, for reducing the signals level of the display-position-moving signal V1 to be given to the pixel G concerned, at a reduction rate decided by the representative accumulated image signal level A. The reduction rate is decided on the basis of an image signal level reduction property as shown in FIG. 10. The image signal-level control circuit 102 supplies the adjustment signal YC to the image signal-level adjustment circuit 4.

More specifically, when the representative accumulated image signal level A is smaller than a predetermined level PY (FIG. 10), the image signal-level control circuit 102 generates an image signal-level adjustment signal YC for supplying the display-position-moving signals V1, without adjustment, to the driver 20. On the other hand, when the representative accumulated image signal level A is larger than the predetermined level PY, the image signal-level control circuit 102 generates an image signal-level adjustment signal YC for reducing the signal levels of the display-position-moving signals V1 in inverse proportion to the size of the representative accumulated image signal levels shown in FIG. 10, and supplies this signal YC to the image signal-level adjustment circuit 4.

The image signal-level control circuit 102 generates an image signal-level adjustment signal YC for each pixel G (each of the pixels G(1,1) to G(n,m)) in the display device 30 (FIG. 9), and then supplies these adjustment signals YC sequentially to the image signal-level adjustment circuit 4.

The image signal-level adjustment circuit 4 reduces the signal level of the display-position-moving signals V1 with a reduction rate indicated by the image signal-level adjustment signal YC, and supplies the resulting movement signal V1 to the driver 20 as a burn-in prevented image signal. The driver 20 generates drive signals for displaying a screen image in accordance with the burn-in prevented image signal, and supplies these drive signals to the display device 30. The display device 30 displays the screen image in accordance with the drive signals supplied from the driver 20.

As described above, the burn-in prevention circuit 10 shown in FIG. 8 calculates an accumulated image signal level AY for each of three color pixel cells of a pixel concerned, and calculates a representative accumulated image signal level A for that pixel on the basis of the accumulated image signal levels AY for the three colors of that pixel. These calculations are performed for each of the pixels of the screen. Then the burn-in prevention circuit 10 reduces the signal level of the image signal (i.e., display-position-moving signal V1) to be given to the pixel concerned, when the representative accumulated image signal level A is bigger than the predetermined level PY. In other words, when the representative accumulated image signal level A is bigger than the predetermined level PY (i.e., when there is a display region where the display image (V1) causes light to be emitted at a level greater than the predetermined signal level for a comparably long period), adjustment of signal levels is performed to reduce the signal levels in that display region on an individual pixel basis.

By calculating an accumulated image signal for each color pixel cell in each pixel G, by determining an representative accumulated image signal level A from the accumulated image signal levels of the three colors of that pixel G, and by reducing the signal levels for the three color pixel cells in the pixel G at the same rate (i.e., signal level reduction rate decided by the representative accumulated image signal level A), the brightness (luminance) level is reduced without changing the color of the pixel G, and burn-in prevention can be realized. More specifically, by reducing the signal levels for the red, green and blue (RGB) pixel cells in a pixel at the same rate, the occurrence of unnatural image colors is prevented. By taking the maximum value of the accumulated image signal levels of the three colors in the pixel G as the representative accumulated image signal level A, burn-in reduction can be performed in accordance with a pixel cell with the greatest burn-in. However, it is not always necessary to take the maximum value of the accumulated image signal levels for the three colors of the pixel as the representative accumulated image signal level, but for example, the average value or the medium value of the accumulated image signal levels of the three colors can be used as the representative accumulated image signal level. If the average value or medium value is used, the burn-in prevention (or reduction) processing is performed in accordance with the average or medium value, and the reduction in brightness (luminance) level is moderated. Accordingly, the difference between the original display image and the burn-in-prevented display image decreases. If the minimum value of the accumulated image signal levels for the three colors are used as the representative accumulated image signal level A, the differences between the original display image and the burn-in-prevented display image can be further suppressed.

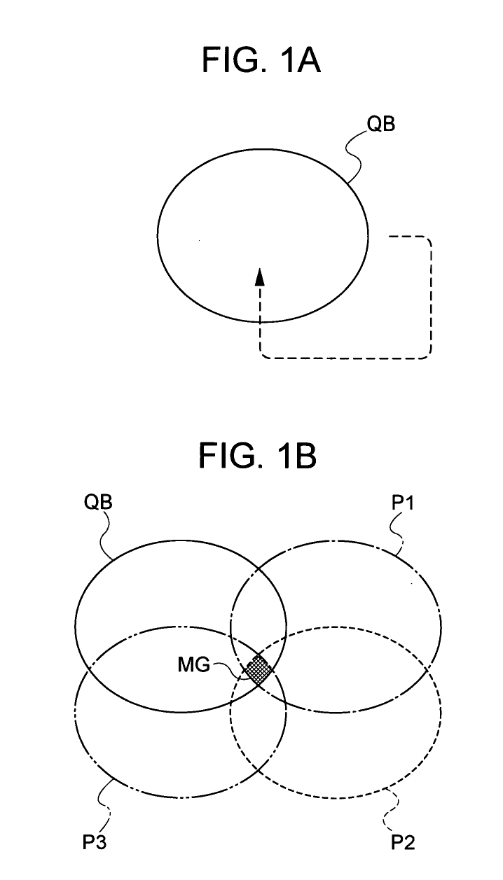

In this manner, even when an overlapping region MG consistently arises in a portion of the display object when moving the display object with orbiting processing as shown in FIG. 1B, reduction of the signal levels for only the region MG is performed. Thus, reliable prevention of burn-in for the display screen is carried out without destroying the natural balance of screen images.

The RGB image signal-levels accumulation calculation circuit 101 shown in FIG. 8 adds signal levels cumulatively for each frame in the most recent ten consecutive frames including the current frame in order to calculate an accumulated image signal level at the time of light emission for each pixel cell. It should be noted that the cumulative addition of the signal levels may be performed by giving a higher weight to the most recent frames. In the embodiment shown in FIG. 8, the orbiting processing circuit 1 moves the display position of the entire image in each frame of the input image signal. However, the orbiting processing circuit 1 can move the display position in a plurality of frames. For example, when the orbiting processing circuit 1 performs movement processing for each ten frames, the orbiting processing circuit 1 may sample the display-position-moving image signals V1 for the ten frames in synchronization with this orbiting movement period, and add signal levels cumulatively for every ten frames, including the current frame, in order to calculate an accumulated image signal level of each pixel cell at the time of light emission. The sampling period must be synchronized with the orbiting movement period of the orbiting processing circuit 1. More specifically, when the sampling period is N frames (N being a positive integer), the orbiting movement period of the orbiting processing circuit 1 must be a positive integer multiple of N frames.

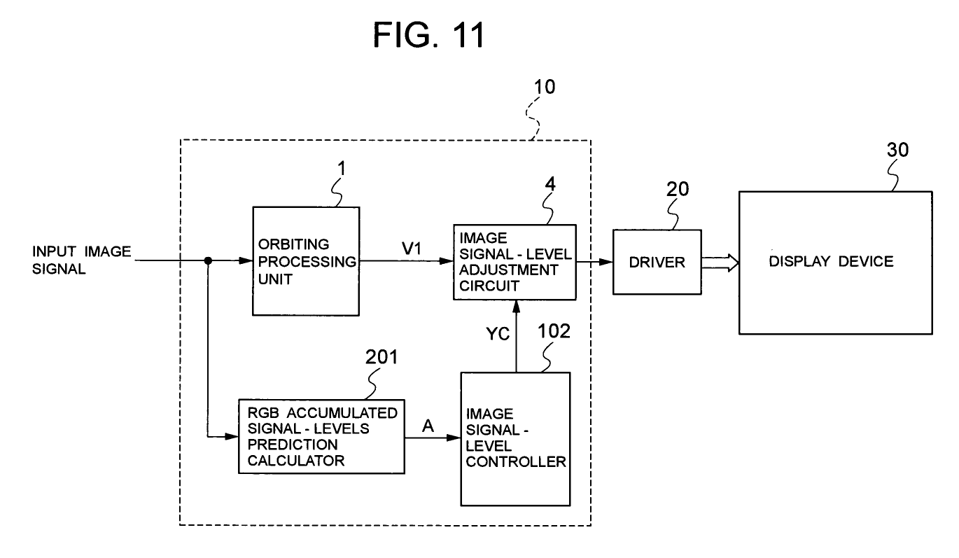

In the RGB image signal-levels accumulation calculation circuit 101 and the image signal-level control circuit 102 shown in FIG. 8, the image signal level adjustment signals YC are generated on the basis of the display-position-moving image signals V1 produced by the orbiting processing. However, as shown in FIG. 11, the image signal level adjustment signals YC may be generated in an RGB accumulated signal-levels prediction circuit 201 and the image signal-level control circuit 102 on the basis of the input image signals prior to the orbiting processing. In this case, the RGB accumulated signal-levels prediction circuit 201 is used in place of the RGB image signal-levels accumulation circuit 101 of FIG. 8. Because the operation of the orbiting processing circuit 1 is known in advance, the RGB accumulated signal-levels prediction circuit 201 calculates the RGB accumulated image signal levels AY while considering the content of the processing to be conducted by the orbiting processing circuit 1. Then, the RGB accumulated signal-levels prediction circuit 201 takes, for example, the maximum accumulated signal level among the RGB accumulated image signal levels AY as the representative accumulated image signal level A. Accordingly, when the same input image signal is entered, an output A of the RGB image signal-levels accumulation circuit 101 of FIG. 8 and an output A of the RGB accumulated signal-levels prediction circuit 201 of FIG. 11 are the same value. When it is known in advance that the input image is nearly a static image, it is sufficient to sample the input image signals at long periods, such as one frame every ten seconds or every minute, and calculate the accumulated signal levels. In this case, the orbiting processing operates in a comparably short amount of time. In such a case, the volume of calculations is reduced by calculating the accumulated signal levels with a method shown in FIG. 11. It is also necessary in the embodiment of FIG. 11 that the sampling period be synchronized to the orbiting movement period of the orbiting processing circuit 1.

In the RGB image signal-levels accumulation circuit 101 and the image signal-level control circuit 102 shown in FIG. 8, processing is performed to reduce the image signal level of each pixel G. However, processing may be performed to uniformly reduce the signal levels for each pixel block formed by a plurality of adjacent pixels G. More specifically, for each pixel block, the sum (or average) of the accumulation calculations results for the image signal levels of the respective pixel cells (C_{R}, C_{G} and C_{B}) is calculated, and a representative accumulation calculation result is selected for that pixel block. For example, the pixel cell whose accumulated image signal level is the highest in the pixel block is detected and taken as the representative accumulated image signal level A. Then, on the basis of the representative accumulated image signal level A, an image signal level adjustment signal YC is generated to uniformly reduce the signal levels of all the pixels in the pixel block at the light emitting time. Alternatively, an average accumulation calculations result for the pixel block may be selected as the representative accumulation calculations result.

A delay circuit for delaying the input image signal for a plurality of frames may be provided upstream of the orbiting processing circuit 1 of FIG. 11. If such delay circuit is provided, the RGB accumulated signal-levels prediction circuit 201 takes into account the display image movement caused by the orbiting processing circuit 1 and cumulatively calculates signal levels of the respective pixels shown by the input image signal for the first frame to the N^{th} frame for a predetermined period, and generates an accumulation image signal level AY showing an accumulation calculation prediction result. More specifically, an accumulation calculation is executed for signal levels from the first frame to the N^{th} frame for each of the red pixel cell C_{R} for emitting red light, the green pixel cell C_{G} for emitting green light, and the blue pixel cell C_{B}, for emitting blue light, belonging to the pixels concerned, while taking into account the display image movement planned by the orbiting processing circuit 1. Then the RGB accumulated signal-levels prediction calculation circuit 201 generates for each pixel G a red accumulated image signal level AY_{R} showing the accumulation calculation result for the image signal level in the red pixel cell C_{R}, a green accumulated image signal level AY_{G} showing the accumulation calculation result for the image signal level in the green pixel cell C_{G}, and a blue accumulated image signal level AY_{B} showing the accumulation calculation result for the image signal level in the blue pixel cell C_{B}, and finds (selects) a representative accumulated image signal level A from the signal levels AY_{R}, AY_{G} and AY_{B}. The representative accumulated image signal level A is sent to the image signal-level control circuit 102.

The image signal-level control circuit 102 generates an image signal level adjustment signal YC for reducing the signal level of the display-position-moving image signal V1 to be applied to the pixel G, with a reduction rate decided by the representative accumulated image signal level A. The reduction rate is decided on the basis of the image signal level reduction property shown in FIG. 10. The image signal-level control circuit 102 then supplies this adjustment signal YC to the signal level adjustment circuit 4.

More specifically, when the accumulated image signal level (i.e., representative accumulated image signal level A) is smaller than the predetermined level PY (FIG. 10), the image signal-level control circuit 102 generates an image signal level adjustment signal YC for supplying the display-position-moving image signal V1, without adjustment, to the driver 20. On the other hand, when the representative accumulated image signal level A is larger than the predetermined level PY, the image signal-level control circuit 102 generates an image signal level adjustment signal YC for reducing the signal level of the display-position-moving image signal V1 in inverse proportion to the size of the signal level shown in FIG. 10, and then supplies this adjustment signal YC to the image signal-level adjustment circuit 4.

The image signal-level control circuit 102 generates an image signal level adjustment signal YC to be applied to each pixel C of the pixels G(1,1) to G(n,m) in the display device 30 shown in FIG. 9, and supplies this adjustment signal YC to the image signal-level adjustment circuit 4.

The image signal-level adjustment circuit 4 reduces the signal level of the display-position-moving image signal V1 of the first frame to the N^{th} frame with the reduction rate indicated by the adjustment signal YC, and supplies the resulting image signal V1 to the driver 20 as burn-in-prevented image signal. The driver 20 generates drive signals for displaying a screen image in accordance with the burn-in-prevented image signal, and supplies these drive signals to the display device 30. The display device 30 displays an image in accordance with the drive signals supplied from the driver 20.

By providing the delay circuit for delaying the input image signal for a plurality of frames before the orbiting processing circuit 1 in FIG. 11, the signal level of the display-position-moving image signal V1 of the first frame to the N^{th} frame can be reduced in accordance with the reduction rate shown by the image signal-level adjustment signal YC calculated on the basis of the input image signal of the first frame to the N^{th} frame.

It should also be noted that a delay circuit for delaying the display-position-moving image signal V1 which has undergone the orbiting processing may be provided in the embodiment of FIG. 8 and in the embodiment of FIG. 11. The delay circuit delays the image signal for a plurality of frames. By introducing the delayed display-position-moving image signal V1 to the signal level adjustment circuit 4, the signal level of the display-position-moving image signal V1 of the first frame to the N^{th} frame can be reduced in accordance with the reduction rate indicated by the adjustment signal YC calculated on the basis of the input image signal of the first frame to the N^{th} frame.

### Third Embodiment

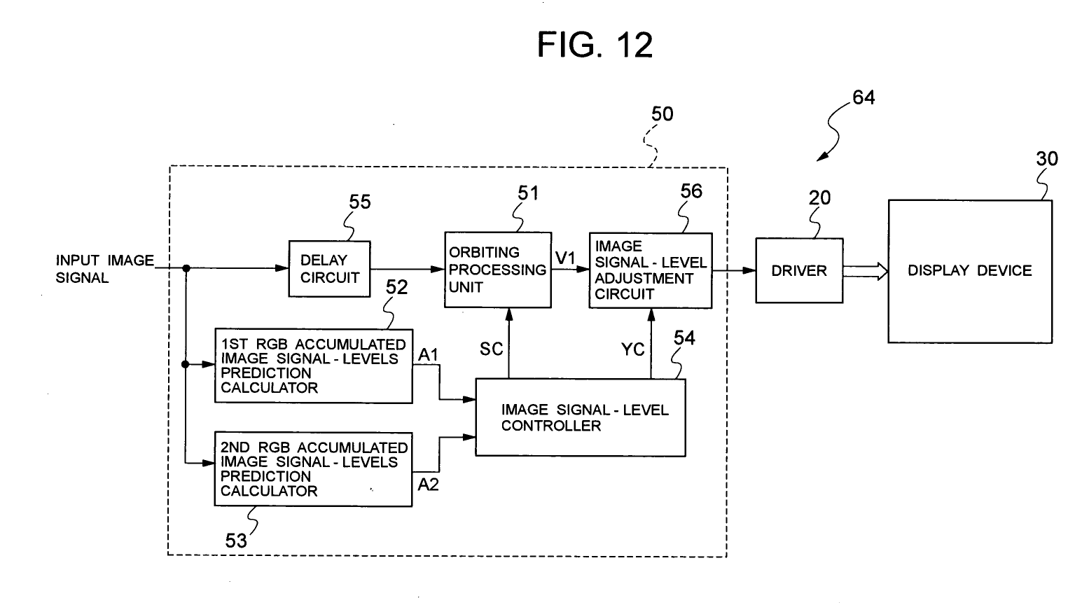

Referring to FIG. 12, a basic structure of an image display apparatus 64 according to a third embodiment of the present invention will be described. The image display apparatus 64 has a display screen burn-in prevention function. Similar reference numerals and symbols are used to designate similar elements and signals in the first, second and third embodiments.

As shown in FIG. 12, the image display apparatus 64 includes a burn-in prevention circuit 50, a driver 20 and a display device 30. The display device 30 has a CRT (Cathode Ray Tube), a plasma display or the like.

The burn-in prevention circuit 50 has an orbiting processing circuit 51, a first RGB accumulated image signal-level prediction circuit 52, a second RGB accumulated image signal-level prediction circuit 53, an image signal-level control circuit 54, a delay circuit 55, and an image signal-level adjustment circuit 56. The delay circuit 55 delays the input image signal for a plurality of frames and supplies the delayed input image signal to the orbiting processing circuit 51.

The orbiting processing circuit 51 supplies to the image signal-level adjustment circuit 56 the display-position-moving image signal V1 obtained by processing the delayed input image signal with orbiting processing selected by a selection signal SC. The selection signal SC selects either a first orbiting processing or a second orbiting processing. The first orbiting processing is different from the second orbiting processing in movement of the display position of the entire screen image for one frame.

The display device 30 has pixels G(1,1) to G(n,m) as shown in FIG. 9. The first RGB accumulated image signal-level prediction circuit 52 takes into account the contents of the first orbiting processing of the orbiting processing circuit 51 for each pixel G of the input image signal, and performs accumulation calculations for image signal levels in a predetermined period for each of three pixel cells belonging to the pixel G concerned. In other words, the accumulation calculations are carried out for a red pixel cell C_{R} for emitting red light, a green pixel cell C_{G} for emitting green light and a blue pixel cell C_{B} for emitting blue light of each pixel G of the display device 30. In this manner, the first RGB accumulated image signal-level prediction circuit 52 generates a red accumulated image signal level AY_{R}l showing the accumulation calculation result for the image signal level in the red pixel cell C_{R}, a green accumulated image signal level AY_{G}l showing the accumulation calculation result for the image signal level in the green pixel cell C_{G} and a blue accumulated image signal level AY_{B}1 showing the accumulation calculation result for the image signal level in the blue pixel cell C_{B}. The first RGB accumulated image signal-level prediction circuit 52 then calculates a first representative accumulated image signal level A1 for the pixel G on the basis of the red accumulated image signal level AY_{R}1, the green accumulated image signal level AY_{G}l and the blue accumulated image signal level AY_{B}1.

The second RGB accumulated image signal-level prediction circuit 53 takes into account the contents of the second orbiting processing of the orbiting processing circuit 51 for each pixel G of the input image signal, and performs accumulation calculations for image signal levels in a predetermined period for each of three pixel cells (namely, the red pixel cell C_{R}, the green pixel cell C_{G} and the blue pixel cell C_{B}) belonging to the pixel G concerned. The accumulation calculations are performed for each pixel G in the display device 30 having the pixels G(1,1) to G(n,m). In this manner, the second RGB accumulated image signal-level prediction circuit 53 generates a red accumulated image signal level AY_{R}2 showing the accumulation calculation result for the image signal level in the red pixel cell C_{R}, a green accumulated image signal level AY_{G}2 showing the accumulation calculation result for the image signal level in the green pixel cell C_{G}, and a blue accumulated image signal level AY_{B}2 showing the accumulation calculation result for the image signal-level in the blue pixel cell C_{B}. The second RGB accumulated image signal-level prediction circuit 53 then calculates a second representative accumulated image signal level A2 for the pixel G on the basis of the red accumulated image signal level AY_{R}2, the green accumulated image signal level AY_{G}2 and the blue accumulated image signal level AY_{B}2.

The image signal-level control circuit 54 first compares the size of the first representative accumulated image signal level Al to the size of the second representative accumulated image signal level A2, both of which correspond to the display pixels in one frame or a portion of one frame. Then the image signal-level control circuit 54 generates the selection signal SC, showing which to select either the first orbiting processing or the second orbiting processing, on the basis of this comparison result, and supplies the selection signal SC to the orbiting processing circuit 51. The image signal-level control circuit 54 also generates an image signal-level adjustment signal YC for each pixel G on the basis of the representative accumulated image signal level corresponding to the selected orbiting processing, and supplies the adjustment signal YC to the image signal-level adjustment circuit 56.

Next, an explanation will be given of the operation of the image display apparatus 64 of the third embodiment. As shown in FIG. 12, the input image signal for the first frame to the N^{th} frame (N being a positive integer) prior to orbiting processing is introduced to the first RGB accumulated image signal-level prediction circuit 52 and the second RGB accumulated image signal-level prediction circuit 53. The first RGB accumulated image signal-level prediction circuit 52 takes into account the contents of the first orbiting processing to calculates for each pixel G, the red accumulated image signal level AY_{R}, the green accumulated image signal level AY_{G} and the blue accumulated image signal level AY_{B}. Then the first RGB accumulated image signal-level prediction circuit 52 calculates the first representative accumulated image signal level Al on the basis of the red accumulated image signal level AY_{R}, the green accumulated image signal level AY_{G} and the blue accumulated image signal level AY_{B}, and supplies the first representative accumulated image signal level Al to the image signal-level control circuit 54. Note that the first representative accumulated image signal level Al may also be, in the same manner as the second embodiment, a maximum, minimum or certain value therebetween of the red accumulated image signal level AY_{R}, the green accumulated image signal level AY_{G} and the blue accumulated image signal level AY_{B}. For example, the first representative accumulated image signal level A1 may be the average value of the red accumulated image signal level AY_{R}, the green accumulated image signal level AY_{G} and the blue accumulated image signal level AY_{B}. The second RGB accumulated image signal-level prediction circuit 53 takes into account the contents of the second orbiting processing to calculate, for each pixel G, the red accumulated image signal level AY_{R}, the green accumulated image signal level AY_{G} and the blue accumulated image signal level AY_{B}. Then the second RGB accumulated image signal-level prediction circuit 53 calculates the second representative accumulated image signal level A2 on the basis of the red accumulated image signal level AY_{R}, the green accumulated image signal level AY_{G} and the blue accumulated image signal level AY_{B}, and supplies the second representative signal level A2 to the image signal-level control circuit 54.

The image signal-level control circuit 54 selects the orbiting processing in which the representative signal level signal is as a whole smaller, on the basis of the comparison result of the size of the first representative accumulated image signal level A1 to the size of the second representative accumulated image signal level A2. The signal levels Al and A2 both correspond to the display pixels in one frame or a portion of one frame. More specifically, the image signal-level control circuit 54 generates the selection signal SC for selecting, from among the first and second orbiting processing, the processing which requires a smaller amount of adjustment of the image signal level to be made by the image signal-level adjustment circuit 56, and supplies this selection signal SC to the orbiting processing circuit 51. The image signal-level control circuit 54 also determines an image signal level reduction rate from FIG. 10 for the pixel concerned, on the basis of the representative accumulated image signal level associated with the orbiting processing of the selected signal level (i.e., either the first representative accumulated image signal level A1 or the second representative accumulated image signal level A2), and supplies an image signal-level adjustment signal YC corresponding to this reduction rate to the signal-level adjustment circuit 56.

The delay circuit 55 supplies an N-frame-delayed input image signal to the orbiting processing circuit 51. The orbiting processing circuit 51 selects one of the first and second orbiting processing in accordance with the selection signal SC supplied by the image signal-level control circuit 54, and supplies the display-position-moving image signal V1, which is obtained by applying the selected orbiting processing on the delayed input image signal, to the image signal level adjustment circuit 56.

The image signal level adjustment circuit 56 adjusts the signal level of the display-position-moving image signal Vl of the first frame to the 20th frame in accordance with an image signal-level adjustment signal YC which is prepared from the input image signal of the first frame to the Nth frame, and supplies the level-adjusted image signal V1 to the driver 20. The driver 20 drives the display device 30 for displaying an image on the basis of the level-adjusted input image signal of the first frame to the Nth frame.

The third embodiment is different from the second embodiment in that selection is possible between the first and second orbiting methods, in order to perform the burn-in prevention with the least amount of adjustment on the image signal level. It should be noted that this embodiment may be modified to select an optimum orbiting processing from three or more orbiting processing before carrying out the burn-in prevention. This prevents the burn-in without, as much as possible, adjusting the signal level.

This application is based on Japanese Patent Application No. 2006-93848 filed on Mar. 30, 2006 and the entire disclosure thereof is incorporated herein by reference.

What is claimed is:

1. An image display apparatus having a burn-in prevention function for a display screen, the image display apparatus comprising:
a display position movement unit for obtaining a display-position-moving image signal by performing, on an input image signal, processing of moving a display position of an entire image in one frame of the input image signal as time elapses; and
an image signal-level adjustment unit for, when there is a region displayed with a constant brightness for a predetermined period in an image indicated by the display-position-moving image signal, adjusting a level of the display-position-moving image signal to reduce the brightness level in the region.

2. The image display apparatus according to claim 1, wherein the image signal-level adjustment unit comprises:
a delay unit for obtaining a delayed display-position-moving image signal by delaying the display-position-moving image signal for an n-frame display period (n is a positive integer);
a first burn-in region candidate detector for detecting, as a first burn-in region candidate, a first region which has a display area equal to or greater than a predetermined size in an image indicated by the display-position-moving image signal, and which has a brightness difference smaller than a predetermined value, the brightness difference being defined by a difference between a minimum brightness level and a maximum brightness level in the first region;
a second burn-in region candidate detector for detecting, as a second burn-in region candidate, a second region which has a display area equal to or greater than a second predetermined size in the image indicated by the delayed display-position-moving image signal, and which has a second brightness difference smaller than a second predetermined value, the second brightness difference being defined by a difference between a minimum brightness level and the maximum brightness level in the second region;
an overlapping region detector for detecting an overlapping region in which the first region indicated by the first burn-in region candidate overlaps with the second region indicated by the second burn-in region candidate;
an accumulated overlapping region storage for storing information representing an accumulated overlapping region;
an overwrite unit for finding a third region where the accumulated overlapping region currently stored in the accumulated overlapping region storage overlaps with the overlapping region, and overwriting information of the third region in the accumulated overlapping region storage, as information of an updated accumulated overlapping region;
a level adjustment signal generator for generating an image-signal-level adjustment signal, in each of the predetermined periods, to reduce the brightness level of the third region indicated by the updated accumulated overlapping region stored in the accumulated overlapping region storage; and
an adjustment unit for adjusting the signal level of the display-position-moving image signal in accordance with the image-signal-level adjustment signal.

3. The image display apparatus according to claim 2, further comprising an average brightness detector for detecting an average brightness of the third region, wherein the level adjustment signal generator maintains the brightness level of the display-position-moving image signal when the average brightness is smaller than a predetermined brightness, and generates the image-signal-level adjustment signal to reduce the brightness level in inverse proportion to the size of the average brightness when the average brightness is greater than the predetermined brightness.

4. The image display apparatus according to claim 2, wherein the level adjustment signal generator generates a second image-signal-level adjustment signal to be applied to a surrounding region around the third region, such that the second image-signal-level adjustment signal gradually changes, toward the third region, the degree of reducing the brightness level in the surrounding region.

5. A display screen burn-in prevention method for preventing burn-in in a display screen of an image display apparatus, the display screen burn-in prevention method comprising the steps of:
obtaining a display-position-moving image signal by performing, on an input image signal, processing of moving a display position of an entire image in one frame of the input image signal as time elapses; and
adjusting, when there is a region displayed with a constant brightness for a predetermined period in an image indicated by the display-position-moving image signal, the brightness level of the display-position-moving image signal to reduce the brightness level in the region.

6. The display screen burn-in prevention method according to claim 5, wherein the step of adjusting the brightness level comprises:
detecting, as a first burn-in region candidate, a first region which has a display area equal to or greater than a first predetermined size in an image indicated by the display-position-moving image signal, and which has a brightness difference smaller than a first predetermined level, the brightness difference being defined by a difference between a minimum brightness level and a maximum brightness level in the first region;
detecting, as a second burn-in region candidate, a second region which has a display area equal to or greater than a second predetermined size in the image indicated by a delayed display-position-moving image signal obtained by delaying the display-position-moving image signal for an n-frame display period (n is a positive integer), and which has a second brightness difference smaller than a second predetermined level, the second brightness difference being defined by a difference between a minimum brightness level and a maximum brightness level in the second region;
detecting an overlapping region in which the first region overlaps with the second region;
storing information representing an accumulated overlapping region in a memory;
overwriting, in the memory, as information representing an updated accumulated overlapping region, a third region where the accumulated overlapping region currently stored in the memory overlaps with the overlapping region;
reading the information representing the updated accumulated overlapping region stored in the memory, and generating an image-signal-level adjustment signal to reduce the brightness level of the updated accumulated overlapping region, in each of the predetermined periods; and
adjusting the brightness level of the display-position-moving image signal in accordance with the image-signal-level adjustment signal.

7. The display screen burn-in prevention method according to claim 6, further comprising a step of detecting an average brightness of the updated accumulated overlapping region, wherein the step of generating the image-signal-level adjustment signal generates the image-signal-level adjustment signal which maintains the brightness level of the display-position-moving image signal when the average brightness is smaller than a predetermined brightness, and which reduces the brightness level in inverse proportion to the size of the average brightness when the average brightness is greater than the predetermined brightness.

8. The display screen burn-in prevention method according to claim 6, wherein the step of generating the image-signal-level adjustment signal generates a second image-signal-level adjustment signal to be applied to a surrounding region around the updated accumulated overlapping region such that the degree of reducing the brightness level changes, toward the updated accumulated overlapping region, in the surrounding region.

9. An image display apparatus having a burn-in prevention function for a display screen of a display device having a plurality of display pixels, the image display apparatus comprising:
a display position movement unit for obtaining a display-position-moving image signal by performing, on an input image signal, processing of moving a display position of an entire image in one frame of the input image signal as time elapses;
an accumulated image signal-level calculator for generating an accumulated image signal level indicating an accumulation calculation result obtained by cumulatively adding the signal levels, indicated by the display-position-moving image signal, for each of the display pixels for a predetermined period; and
a level adjustment unit for adjusting the signal level of the display-position-moving image signal to be supplied to each of the display pixels, in accordance with the accumulated image signal level to be given to the display pixel concerned.

10. An image display apparatus having a burn-in prevention function for a display screen of a display device having a plurality of display pixels, the image display apparatus comprising:
a display position movement unit for obtaining a display-position-moving image signal by performing, on an input image signal, processing of moving a display position of an entire image in one frame of the input image signal as time elapses;
an accumulated image signal-level prediction calculator for generating an accumulated image signal level indicating an accumulation calculation prediction result obtained by cumulatively adding the signal levels, indicated by the input image signal, for each of the display pixels for a predetermined period, taking into account movement based on the display-position-moving image signal; and
an image signal-level adjustment unit for adjusting the signal level of the display-position-moving image signal corresponding to each of the display pixels in accordance with the accumulated image signal level to be given to the display pixel concerned.

11. The image display apparatus according to claim 9, wherein the image signal-level adjustment unit maintains the signal level of the display-position-moving image signal when the accumulated image signal level is smaller than a predetermined value, and performs adjustment to reduce the signal level in inverse proportion to the size of the accumulated image signal level when the accumulated image signal level is greater than the predetermined value.

12. The image display apparatus according to claim 9, wherein each of the display pixels is formed from a first color pixel emitting light of a first color, and a second color pixel emitting light of a second color different from the first color, the accumulated image signal-level calculator or the accumulated image signal-level prediction calculator includes a unit for generating, as a first color accumulated image signal level, the accumulated image signal level corresponding to the first color pixels, and for generating, as a second color accumulated image signal level, the accumulated image signal level corresponding to the second color pixels, and the image signal-level adjustment unit calculates, for each of the display pixels, a representative accumulated image signal level for the display pixels on the basis of the first color accumulated image signal level of the first color pixels belonging to the display pixels and the second color accumulated image signal level of the second color pixels belonging to the display pixels, and adjusts the signal level of the display-position-moving image signal corresponding to the first and second color pixels belonging to the display pixels, in accordance with the representative accumulated image signal level.

13. The image display apparatus according to claim 12, wherein the representative accumulated image signal level of the display pixels is the larger accumulated image signal level among the first color accumulated image signal level of the first color pixels belonging to the display pixels and the second color accumulated image signal level of the second color pixels belonging to the display pixels.

14. The image display apparatus according to claim 12, wherein the representative accumulated image signal level of the display pixels is an accumulated image signal level in the middle of the first color accumulated image signal level of the first color pixels belonging to the display pixels and the second color accumulated image signal level of the second color pixels belonging to the display pixels.

15. The image display apparatus according to claim 12, wherein the image signal-level adjustment unit maintains the signal level of the display-position-moving image signal when the representative accumulated image signal level is smaller than a predetermined value, and performs adjustment to reduce the signal level in inverse proportion to the size of the representative accumulated image signal level when the representative accumulated image signal level is greater than the predetermined value.

16. An image display apparatus having a burn-in prevention function for a display screen of a display device having a plurality of display pixels, the image display apparatus comprising:
a display position movement unit for obtaining a display-position-moving image signal by performing, on an input image signal, processing of moving a display position of an entire image in one frame of the input image signal as time elapses;
an accumulated image signal-level calculator for generating an accumulated image signal level indicating an accumulation calculation result obtained by cumulatively adding the signal levels, indicated by the display-position-moving image signal, for each display pixel block formed from the plurality of display pixels, for a predetermined period; and
an image signal-level adjustment unit for adjusting the signal level of the display-position-moving image signal corresponding to the display pixels belonging to the display pixel block in accordance with the accumulated image signal level corresponding to the display pixel block.

17. An image display apparatus having a burn-in prevention function for a display screen of a display device having a plurality of display pixels, the image display apparatus comprising:
a display position movement unit for obtaining a display-position-moving image signal by performing, on an input image signal, processing of moving a display position of an entire image in one frame of the input image signal as time elapses;
an accumulated image signal-level prediction calculator for generating an accumulated image signal level indicating an accumulation calculation prediction result obtained by cumulatively adding the signal levels, indicated by the input image signal, for each display pixel block formed from the plurality of display pixels, for a predetermined period, taking into account movement based on the display-position-moving image signal; and
an image signal-level adjustment unit for adjusting the signal level of the display-position-moving image signal corresponding to the display pixels belonging to the display pixel block in accordance with the accumulated image signal level corresponding to the display pixel block.

18. The image display apparatus according to claim 16, wherein the image signal-level adjustment unit maintains the signal level of the display-position-moving image signal when the accumulated image signal level is smaller than a predetermined value, and performs adjustment to reduce the signal level in inverse proportion to the size of the accumulated image signal level when the accumulated image signal level is greater than the predetermined value.

19. The image display apparatus according to claim 16, wherein each of the display pixels is formed from a first color pixel emitting light of a first color, and a second color pixel emitting light of a second color different from the first color, the accumulated image signal-level calculator or the accumulated image signal-level prediction calculator includes a unit for generating, as a first color accumulated image signal level, the accumulated image signal level based on the display-position-moving image signal corresponding to the first color pixels, and for generating, as a second color accumulated image signal level, the accumulated image signal level based on the display-position-moving image signal corresponding to the second color pixels, and the image signal-level adjustment unit calculates, for each of display pixel blocks, a representative accumulated image signal level for the display pixel block on the basis of the first color accumulated image signal level of the first color pixels belonging to the display pixels in the display pixel block and the second color accumulated image signal level of the second color pixels belonging to the display pixels in the display pixel block, and adjusts the signal level of the display-position-moving image signal corresponding to the first and second color pixels belonging to the display pixel block, in accordance with the representative accumulated image signal level.

20. The image display apparatus according to claim 19, wherein the image signal-level adjustment unit maintains the signal level of the display-position-moving image signal when the representative accumulated image signal level is smaller than a predetermined value, and performs adjustment to reduce the signal level in inverse proportion to the size of the representative accumulated image signal level when the representative accumulated image signal level is greater than the predetermined value.

21. An image display apparatus having a burn-in prevention function for a display screen of a display device having a plurality of display pixels, the image display apparatus comprising:
a display position movement unit for performing, on an input image signal, processing of moving a display position of an entire image in one frame based on the input image signal as time elapses, to generate a first display-position-moving image signal and a second display-position-moving image signal in which the display position of the entire image moves as time elapses in a movement pattern different from the first display-position-moving image signal;
a first accumulated image signal-level prediction calculator for generating a first accumulated image signal level indicating an accumulation calculation prediction result obtained by cumulatively adding the signal levels, indicated by the input image signal, for each of the display pixels for a predetermined number of frames, taking into account movement based on the first display-position-moving image signal;
a second accumulated image signal-level prediction calculator for generating a second accumulated image signal level indicating an accumulation calculation prediction result obtained by cumulatively adding the signal levels, indicated by the input image signal, for each of the display pixels for a predetermined number of frames, taking into account movement based on the second display-position-moving image signal; and
an image signal-level controller for generating a selection signal indicating one of the first display-position-moving image signal and the second display-position-moving image signal, on the basis of a comparison result of the level of the first display-position-moving image signal and the level of the second display-position-moving image signal corresponding to the display pixels in one frame or a portion of one frame, wherein the display position movement unit alternatively generates one of the first display-position-moving image signal and the second display-position-moving image signal, as indicated by the selection signal.

22. A display screen burn-in prevention method for a display device having a plurality of display pixels, comprising the steps of:
obtaining a display-position-moving image signal by performing, on an input image signal, processing of moving a display position of an entire image in one frame based on the input image signal as time elapses;
generating an accumulated image signal level indicating an accumulation calculation result obtained by cumulatively adding the signal levels, indicated by the display-position-moving image signal, for each of the display pixels for a predetermined period; and
adjusting the signal level of the display-position-moving image signal corresponding to the display pixels in accordance with the accumulated image signal level corresponding to the display pixels.

23. A display screen burn-in prevention method for a display device having a plurality of display pixels, comprising the steps of:
obtaining a display-position-moving image signal by performing, on an input image signal, processing of moving a display position of an entire image in one frame based on the input image signal as time elapses;
generating an accumulated image signal level indicating an accumulation calculation prediction result obtained by cumulatively adding the signal levels, indicated by the input image signal, for each of the display pixels for a predetermined period, taking into account movement based on the display-position-moving image signal; and
adjusting the signal level of the display-position-moving image signal corresponding to the display pixels in accordance with the accumulated image signal level corresponding to the display pixels.

24. A display screen burn-in prevention method for a display device having a plurality of display pixels, comprising the steps of:
obtaining a display-position-moving image signal by performing, on an input image signal, processing of moving a display position of an entire image in one frame based on the input image signal as time elapses;
generating an accumulated image signal level indicating an accumulation calculation result obtained by cumulatively adding the signal levels, indicated by the display-position-moving image signal, for each display pixel block formed from the plurality of display pixels, for a predetermined period; and
adjusting the signal level of the display-position-moving image signal corresponding to the display pixels belonging to the display pixel block in accordance with the accumulated image signal level corresponding to the display pixel block.

25. A display screen burn-in prevention method for a display device having a plurality of display pixels, comprising the steps of:
obtaining a display-position-moving image signal by performing, on an input image signal, processing of moving a display position of an entire image in one frame based on the input image signal as time elapses;
generating an accumulated image signal level indicating an accumulation calculation prediction result obtained by cumulatively adding the signal levels, indicated by the input image signal, for each display pixel block formed from the plurality of display pixels, for a predetermined period, taking into account movement based on the display-position-moving image signal; and
adjusting the signal level of the display-position-moving image signal corresponding to the display pixels belonging to the display pixel block in accordance with the accumulated image signal level corresponding to the display pixel block.

26. A display screen burn-in prevention method for a display device having a plurality of display pixels, comprising the steps of:
performing, on an input image signal, processing of moving a display position of an entire image in one frame based on the input image signal as time elapses, to generate a first display-position-moving image signal and a second display-position-moving image signal in which the display position of the entire image moves as time elapses in a movement pattern different from the first display-position-moving image signal;
generating a first accumulated image signal level indicating an accumulation calculation prediction result obtained by cumulatively adding the signal levels, indicated by the input image signal, for each of the display pixels for a predetermined number of frames, taking into account movement based on the first display-position-moving image signal;
generating a second accumulated image signal level indicating an accumulation calculation prediction result obtained by cumulatively adding the signal levels, indicated by the input image signal, for each of the display pixels for a predetermined number of frames, taking into account movement based on the second display-position-moving image signal; and
generating a selection signal indicating one of the first display-position-moving image signal and the second display-position-moving image signal, on the basis of a comparison result of the level of the first display-position-moving image signal and the level of the second display-position-moving image signal corresponding to the display pixels in one frame or a portion of one frame, wherein in the display position movement step, one of the first display-position-moving image signal and the second display-position-moving image signal as indicated by the selection signal is alternatively generated.
